(19) United States
(12) Patent Application Publication
(10) Pub. No.: US 2009/0174985 A1
(43) Pub. Date: Jul. 9, 2009

(54) Ceramic capacitor assembly

(75) Inventor: Yu-Cheng Fang, Taipei (TW)

Correspondence Address: COOPER & DUNHAM, LLP, 30 Rockefeller Plaza, 20th Floor, NEW YORK, NY, 10112, US

(73) Assignee: Holy Stone Enterprise Co., Ltd.

(21) Appl. No.: 12/006,554

(22) Filed: Jan. 3, 2008

(51) Int. Cl. H01G 4/12

(52) U.S. Cl. 361/321.1

(57) ABSTRACT

A ceramic capacitor assembly has a ceramic capacitor and a cushion. The ceramic capacitor has a body, two terminals formed respectively on the body and two legs connecting to and protruding respectively from the terminals. The cushion is a resilient material and has an upper surface corresponding to and mounted adjacent to the ceramic capacitor, a lower surface, an outer edge and two fastening detents. The detents correspond to the legs and are provided for legs to fasten to the cushion. The ceramic capacitor and the cushion are easily assembled and reduce cost and complexity of manufacture.

### BACKGROUND OF THE INVENTION

1. Field of Invention

The present invention relates to a ceramic capacitor assembly, and more particularly to a ceramic capacitor assembly that comprises a capacitor with two legs and a cushion to prevent the ceramic capacitor from deforming or breaking and can be mounted securely on a printed circuit board by surface mount technology.

2. Description of the Related Art

Passive components, such as capacitors, resistors, inductors or the like, can be mounted on a printed circuit board (PCB) by two different ways.

In a first method, the PCB has an upper surface, a lower surface and two holes. The holes are defined through the PCB. The passive component has a body and two legs. The body is mounted on the upper surface of the PCB. The legs are mounted on the body, protrude through the holes of the PCB and before being bent and soldered onto the lower surface of the PCB. Therefore, mounting procedures of the passive component on the PCB using two legs comprises complex steps.

In a second method, the passive component is a surface mounted device (SMD) and has a body and two terminals. The body has two ends. The terminals are respectively mounted on the ends of the body. When the passive component is mounted on the PCB, the terminals are soldered on the PCB. The procedure to mount the passive component on the PCB directly is easy and fast. However, when the passive component is a ceramic capacitor, the PCB may warp or deform whilst the terminals are being soldered onto the PCB and the passive component may be damaged or even break. Thus, the passive components, especially ceramic passive components are easily damaged.

With reference to FIGS. 11 and 12, Taiwan patent No. M262821 discloses a capacitor assembly comprising a ceramic capacitor (40) and an insulating cover (50). The ceramic capacitor (40) has a body (42), two terminals (43) and two legs (41). The body (42) has two ends. The terminals (43) are respectively formed on the ends of the body (42). The legs (41) connect respectively to the terminals (43) and are soldered on an upper surface of the PCB.

The insulating cover (50) covers the body (42) and the terminals (43), allows the legs (41) to protrude from the insulating cover (50) and has a bottom and multiple supports (51). The supports (51) are formed on and protrude from the bottom of the insulating cover (50) and are mounted in contact with a PCB. Therefore the legs (41) can be bent under and mounted below the bottom of the insulating cover (50) and between the supports (51) so the ceramic capacitor (40) can be mounted securely on the PCB. Thus, the legs (41) and the insulating cover (50) prevent the body (42) and the terminals (43) from being mounted directly on the upper surface of the PCB.

However, the insulating cover (50) entirely covers the body (42) and the terminals (43), so much material is wasted raising costs.

To overcome the shortcomings, the present invention provides ceramic capacitor to mitigate or obviate the aforementioned.

### SUMMARY OF THE INVENTION

The primary objective of the present invention is to provide a ceramic capacitor assembly comprising two legs and a cushion that allow the ceramic capacitor to be mounted securely on a print circuit board by surface mount technology (SMT) and prevent the ceramic capacitor from deforming or breaking.

To achieve the objective, the ceramic capacitor assembly in accordance with the present invention comprises a ceramic capacitor and a cushion. The ceramic capacitor has a body, two terminals and two legs. The body has a bottom. The terminals are formed respectively on the body. The legs connect to and protrude respectively from the terminals. The cushion is a resilient material and has an upper surface, a lower surface being mounted on the PCB, an outer edge and two fastening detents. The upper surface of the cushion corresponds to and is mounted adjacent to the ceramic capacitor. The detents correspond to the legs and are provided for legs to fasten to the cushion.

The ceramic capacitor and the cushion are easily assembled and the cushion can replace an insulating cover of a conventional ceramic capacitor assembly to reduce costs and complexity of manufacture.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a ceramic capacitor assembly in accordance with the present invention with a first variant of legs;

FIG. 2 is a perspective view of the ceramic capacitor assembly in FIG. 1;

FIG. 3 is a side view in partial section of the ceramic capacitor assembly in FIG. 1;

FIG. 4 is an exploded perspective view of a ceramic capacitor assembly in accordance with the present invention with a second variant of legs;

FIG. 5 is a side view in partial section of the ceramic capacitor assembly in FIG. 4;

FIG. 6 is an exploded perspective view of a ceramic capacitor assembly in accordance with the present invention with a third variant of legs;

FIG. 7 is a perspective view of the ceramic capacitor assembly in FIG. 6;

FIG. 8 is a perspective view of the ceramic capacitor assembly in accordance with the present invention with a fourth variant of legs;

FIG. 9 is a perspective view of the ceramic capacitor assembly in accordance with the present invention with each recess formed from a through hole toward a center of a cushion;

FIG. 10 is a perspective view of the ceramic capacitor assembly in accordance with the present invention showing two receiving notches formed respectively in outer edges of a cushion;

FIG. 11 is a cross sectional side view of a conventional ceramic capacitor in accordance with prior art; and

FIG. 12 is a cross sectional side view of the conventional ceramic capacitor in FIG. 11, showing legs mounted below a bottom of an insulating cover.

### DETAILED DESCRIPTION OF THE INVENTION

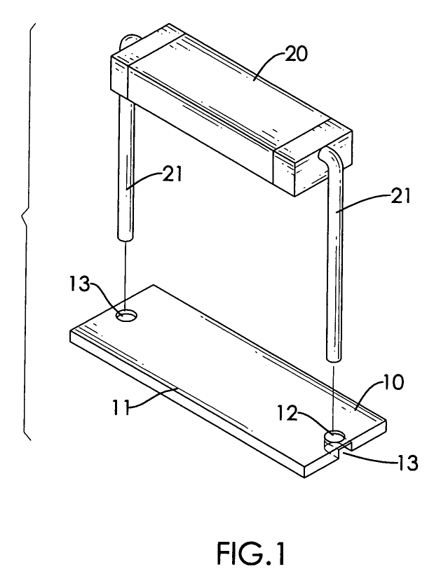

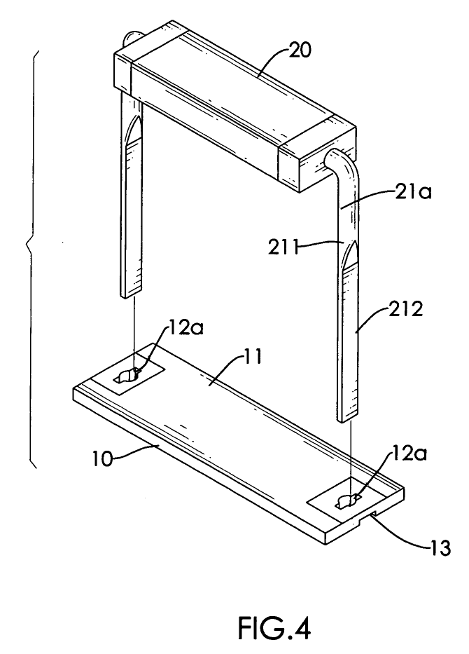

With reference to FIGS. 1 and 4, a ceramic capacitor assembly in accordance with the present invention is mounted on a printed circuit board (PCB) as a surface mounted device and has a ceramic capacitor (20) and a cushion (10).

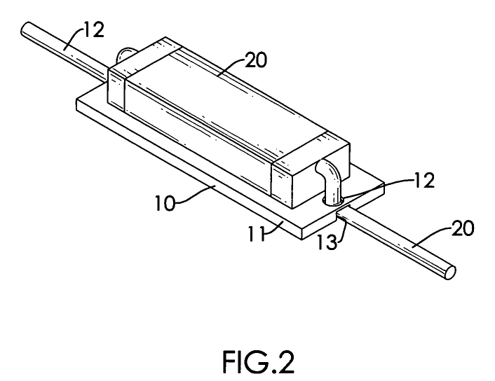

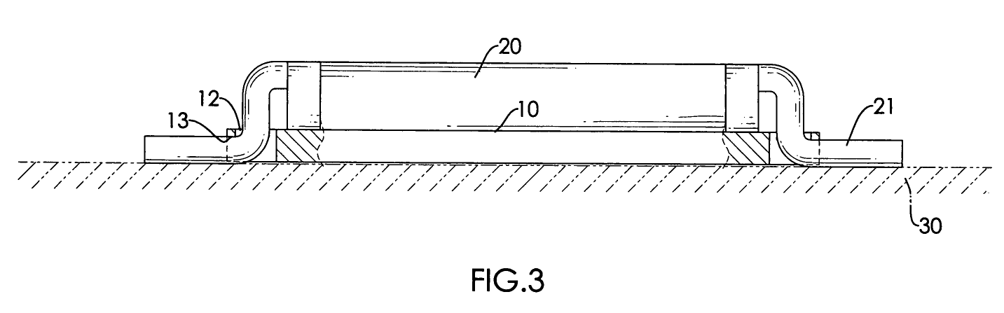

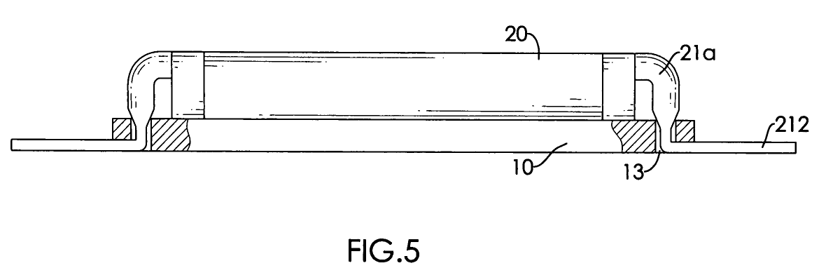

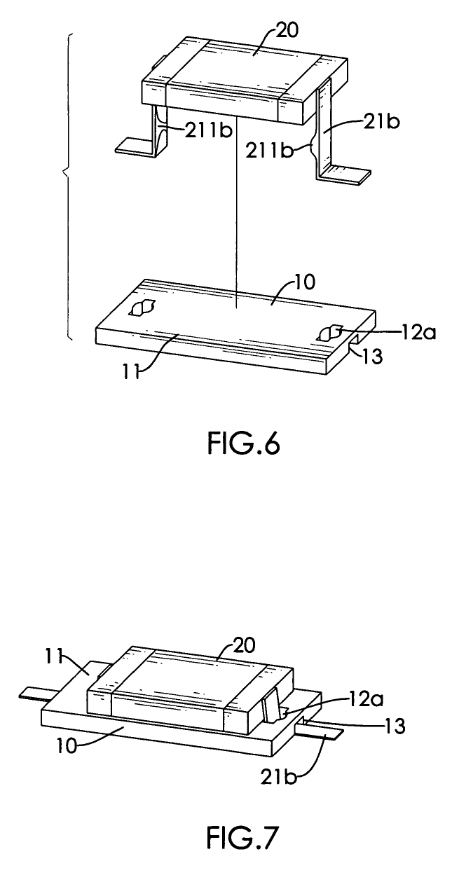

The ceramic capacitor (20) may be rectangular (such as a multi-layer ceramic capacitor) or a disk-shape (parallel board capacitor) and has a body, two terminals and two legs (21, 21a, 21b, 21c). The body has a bottom. The terminals are formed on the body. With further reference to FIGS. 2, 3, 5, 6 and 8, the legs (21, 21a, 21b, 21c) are connected respectively to and protrude respectively from the terminals of the capacitor (20). Each leg (21, 21a, 21b, 21c) is bent, has a proximal segment and a distal segment. The proximal segment is connected to the body. The distal segment is formed on and protrudes perpendicularly from the proximal segment and may be parallel to the bottom of the body of the capacitor (20) or may be formed an L-shaped. In a first variant of the capacitor, each leg (21) is a rod. In a second variant, each leg (21a) has the proximal segment being a rod segment (211) and has the distal segment being a flattened segment (212). In a third variant, each leg (21c) is parallelepiped and the proximal segment of the leg (21c) has an inner surface. The inner surface has a protrusion (211b). The protrusion (211b) protrudes from the inner surface. In a fourth variant, each leg (21c) is parallelepiped.

The cushion (10) is made of resilient material, such as resin, may be rectangular, circular or other shapes, is mounted on the PCB and has an upper surface (11), a lower surface, an outer edge, two fastening detents.

The upper surface (11) corresponds to and is mounted adjacent to the ceramic capacitor (20) and may be flat.

The lower surface is flat and is opposite to the upper surface (11).

With further reference to FIGS. 7, 9 and 10, the fastening detents correspond to the legs (21, 21a, 21b, 21c) and are provided for legs (21, 21a, 21b, 21c) to fasten to the cushion (10).

In a first embodiment, each fastening detent comprises a through hole (12, 12a) and a recess (13, 13a, 13b).

The through holes (12, 12a) are defined through the cushion (10), correspond to the legs (21, 21a, 21b, 21c) and allow the legs (21, 21a, 21b, 21c) to extend respectively through the through holes (12, 12a). Each through hole (12) may be circular, be larger than and correspond to the legs (21). Each through hole (12a) may be a slot and may correspond to the flattened segment (212) thereby only allowing the flattened segment (212) to extend through the through hole (12a) and may correspond to the protrusion (211b) of a parallelepiped leg (21b) thereby allowing the parallelepiped leg (21b) to be mounted securely in the slot (12a). Therefore, the capacitor (20) is held out of contact with the upper surface (11) of the cushion (10).

Each recess (13, 13a, 13b) is formed in the lower surface from the through hole (12, 12a), communicates with one of the through holes (12, 12a) and is mounted around a corresponding one of the legs (21, 21a, 21b, 21c).

In a first variant, the recess (13) is formed from the through holes (12, 12a) to the outer edge of the cushion (10) to allow the distal segment of the corresponding leg (21, 21a, 21b, 21c) to be mounted flush with the lower surface of the cushion (10) after being bent, thereby making mounting on the PCB easily.

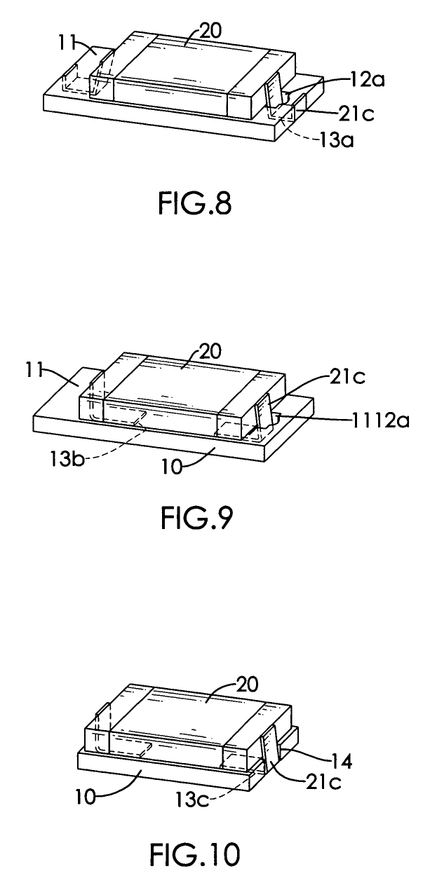

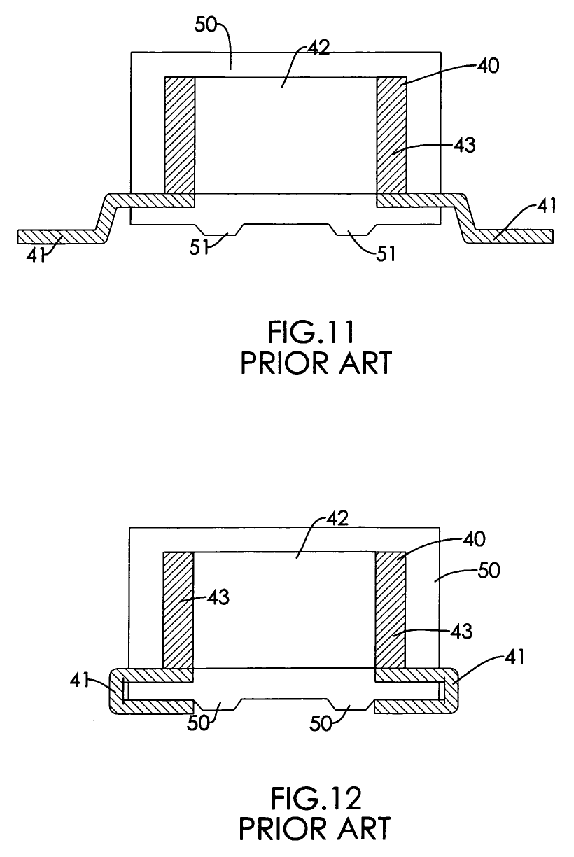

In a second variant, the recess (13a) as FIG. 8 is formed from one of the through holes (12, 12a) to a corresponding one of the outer edge of the cushion (10) and further extends along the outer edge upward to the upper surface (11) to become L-shaped. The recess (13a) allows the distal segment of the corresponding leg (21b) to be bent to correspond and be mounted along the recess (13a), so part of the distal segment of the corresponding leg (21b) is flush with the lower surface of the cushion (10) and part of the distal segment is flush with the outer edge of the cushion (10). Therefore, the ceramic capacitor (20) fastens securely to the cushion (10) and the ceramic capacitor (20) also can be mounted on the PCB easily.

In a third variant, the recess (13b) as FIG. 9 is formed from the through holes (12, 12a) to a center of the cushion (10) to allow the distal segment of the corresponding leg (21, 21a, 21b, 21c) to be mounted flush with the lower surface of the cushion (10) after being bent, thereby making mounting on the PCB easily.

In a preferred embodiment, the cushion (10) is rectangular and further has two ends. Each recess (13, 13a, 13b) is formed in the lower surface from one of the through hole (12, 12a) to a corresponding one of the ends of the cushion (10).

In a second embodiment, each fastening detent comprises a receiving notch (14) and a recess (13c). Each receiving notch (14) is formed in one of the outer edges from the upper surface to the lower surface and corresponds to and receives partially the proximal segment. The recess (13c) as FIG. 10 is formed from the notch (14) to a center of the cushion (10) and allows the distal segment of the corresponding leg (21c) to be mounted flush with the lower surface of the cushion (10) after being bent, thereby making mounting on the PCB easily.

In a preferred embodiment, the cushion (10) is rectangular and further has two ends. The receiving notches (14) are formed respectively in the ends of the cushion (10).

Therefore, the legs (21, 21a, 21b, 21c) may hold the body and the terminals of the ceramic capacitor (20) out of contact with the cushion (10), so the ceramic capacitor (20) is not mounted directly on the PCB to prevent the ceramic capacitor (20) from being damaged during mounting and soldering.

Furthermore, the cushion (10) is mounted between the body and the terminals of the ceramic capacitor (20) and the PCB, so can support the whole body of the ceramic capacitor (20). Accordingly, the ceramic capacitor (20) can be mounted securely on the PCB.

Moreover, the ceramic capacitor (20) and the cushion (20) are easily assembled and the cushion (20) can replace an insulating cover of a conventional ceramic capacitor assembly to save money and manufacturing costs and complexity.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A ceramic capacitor assembly comprising:
a ceramic capacitor having
a body;
two terminals formed on the body; and
two legs connected respectively to the terminals, protruding respectively from the terminals and each having
a proximal segment connected to the body; and
a distal segment formed on and protruding perpendicularly from the proximal segment and being bent;
a cushion being made of resilient material and having
an upper surface corresponding to and mounted adjacent to the ceramic capacitor;
a lower surface;
an outer edge;
two fastening detents corresponding to the legs and being provided for legs to fasten to the cushion.

2. The ceramic capacitor assembly as claimed in claim 1, wherein each fastening detent has
a through hole being defined through the cushion, corresponding to and allowing the legs to extend respectively through the through holes and being circular; and
a recess being formed in the lower surface of the cushion, communicating respectively with the through holes and receiving the distal segment of the leg.

3. The ceramic capacitor assembly as claimed in claim 2, the recess is formed from the through holes to the outer edge of the cushion.

4. The ceramic capacitor assembly as claimed in claim 2, the recess is formed from one of the through holes to a corresponding one of the outer edge of the cushion and further extends along the outer edge upward to the upper surface, which allows the distal segment of the corresponding leg be bent to correspond and be mounted along the recess.

5. The ceramic capacitor assembly as claimed in claim 2, wherein
the recess is formed from the through holes to a center of the cushion; and
each leg is parallelepiped.

6. The ceramic capacitor assembly as claimed in claim 3, wherein
the cushion is rectangular and further has two ends; and
each recess is formed in the lower surface from one of the through holes to a corresponding one of the ends of the cushion.

7. The ceramic capacitor assembly as claimed in claim 4, wherein
the cushion is rectangular and further has two ends; and
each recess is formed in the lower surface from one of the through holes to a corresponding one of the ends of the cushion.

8. The ceramic capacitor assembly as claimed in claim 5, wherein
the cushion is rectangular and further has two ends; and
each recess is formed in the lower surface from one of the through holes to a corresponding one of the ends of the cushion.

9. The ceramic capacitor assembly as claimed in claim 1, wherein each fastening detent has
a receiving notch being formed in one of the outer edges from the upper surface to the lower surface and corresponding to and receives partially the proximal segment; and
a recess being formed from the notch to a center of the cushion.

10. The ceramic capacitor assembly as claimed in claim 9, wherein
the cushion is rectangular and further has two ends; and
the receiving notches are formed respectively in the ends of the cushion.

11. The ceramic capacitor assembly as claimed in claim 1, wherein
the cushion is made of resin; and
the upper surface of the cushion is flat.

12. The ceramic capacitor assembly as claimed in claim 11, wherein
the lower surface of the cushion is flat; and
the recesses allow the distal segment of each leg to be mounted flush with the lower surface of the cushion.

13. The ceramic capacitor assembly as claimed in claim 3, wherein
each leg is a rod and has a diameter and the distal segment of each leg is a flattened segment; and
each through hole is a slot corresponding to the flattened segment of one of the legs and has a diameter that is larger than the diameter of the leg.

14. The ceramic capacitor assembly as claimed in claim 2, wherein
each leg is a rod and has a diameter; and
each through hole is circular corresponding to the legs and has a diameter that is larger than the diameter of the leg.

15. The ceramic capacitor assembly as claimed in claim 4, wherein
the distal segment of each leg is a flattened segment; and
each through hole is a slot and corresponds to the flattened segment of one of the legs.

16. The ceramic capacitor assembly as claimed in claim 2, wherein
the recess is formed from the through holes to a center of the cushion;
the distal segment of each leg is a flattened segment; and
each through hole is a slot and corresponds to the flattened segment of one of the legs.

17. The ceramic capacitor assembly as claimed in claim 9, wherein each leg is parallelepiped.

18. The ceramic capacitor assembly as claimed in claim 3, wherein
each leg is parallelepiped and the proximal segment of the leg has an inner surface with a protrusion that is protruding from the inner surface; and
each through hole is a slot corresponding to the protrusion of the leg.

19. The ceramic capacitor assembly as claimed in claim 4, wherein
each leg is parallelepiped and the proximal segment of the leg has an inner surface with a protrusion that is protruding from the inner surface; and
each through hole is a slot corresponding to the protrusion of the leg.

20. The ceramic capacitor assembly as claimed in claim 5, wherein
the proximal segment of the leg has an inner surface with a protrusion that is protruding from the inner surface; and
each through hole is a slot corresponding to the protrusion of the leg.
